(19) United States
(12) Patent Application Publication
(10) Pub. No.: US 2006/0215089 A1
(43) Pub. Date: Sep. 28, 2006

(54) Liquid crystal display

(76) Inventors: Nam-Seok Roh, Seongnam-si (KR); Young-Chol Yang, Seongnam-si (KR); Mun-Pyo Hong, Seongnam-si (KR)

Correspondence Address: CANTOR COLBURN, LLP, 55 GRIFFIN ROAD SOUTH, BLOOMFIELD, CT, 06002, US

(21) Appl. No.: 11/363,230

(22) Filed: Feb. 27, 2006

(30) Foreign Application Priority Data
Mar. 25, 2005 (KR) 10-2005-0025062

(51) Int. Cl. G02F 1/1335

(52) U.S. Cl. 349/114

(57) ABSTRACT

An LCD includes a plurality of gate lines, a plurality of data lines intersected with the gate lines, a plurality of switching elements connected with the gate lines and the date lines, an insulating layer formed on the switching element, a transflective layer formed on the insulating layer and including a plurality of light-reflecting elements for reflecting light and a lens layer for refracting incident light from the exterior toward the light-reflecting elements, and a plurality of pixel electrodes formed on the transflective layer and connected with the switching elements. The transflective layer 186 including the lens layer with protrusions and the light-reflecting elements enables an entire aperture area of all pixels to be used, thereby maximizing transmittance without any loss of reflectance.

### CROSS REFERENCE TO RELATED APPLICATION

This application claims priority to and the benefit of Korean Patent Application No. 10-2005-0025062, filed on Mar. 25, 2005, which is hereby incorporated by reference for all purposes as if fully set forth herein.

### BACKGROUND OF THE INVENTION

1. Field of the Invention

The present invention relates generally to a liquid crystal display, and more particularly, to a transflective liquid crystal display.

2. Description of the Related Art

Liquid crystal displays (LCDs) are a popular type of flat panel display device. Generally, an LCD includes a pair of panels each having electrodes on an inner surface, and a dielectric anisotropy liquid crystal layer interposed between the panels. Varying the voltage difference between the field generating electrodes, i.e., the variation in the strength of an electric field generated by the electrodes, changes the transmittance of the light passing through the LCD so that desired images may be obtained by controlling the voltage difference between the electrodes.

Depending on the type of light source used for displaying an image, the LCD may be divided into three types: a transmissive LCD, a reflective LCD, and a transflective LCD. In the transmissive LCDs, the pixels are illuminated from behind using a backlight. In the reflective LCDs, the pixels are illuminated from the front using incident light originating from the ambient environment. The transflective LCDs combine transmissive and reflective characteristics. Under medium light conditions such as an indoor environment or under a complete darkness conditions, transflective LCDs are operated in the transmissive mode, while under very bright conditions such as an outdoor environment, transflective LCDs operate in the reflective mode.

In the transflective LCDs, each pixel includes a transmissive area and a reflective area. Since the reflective areas, formed of an opaque metal, shield light from the backlight, the pixels have a low transmittance. However, when the transmissive areas are enlarged to increase the transmittance, visibility deteriorates because the reflective areas are reduced proportionately as much as the transmissive areas are enlarged.

### SUMMARY OF THE INVENTION

The present invention provides a transflective LCD that increases transmittance while maintaining a proper reflectance.

Additional features of the invention will be set forth in the description which follows, and in part will be apparent from the description, or may be learned by practice of the invention.

The present invention discloses an LCD, including a plurality of signal lines; a switching element connected with the signal lines; an insulating layer provided on the switching element; a transflective layer provided on the insulating layer and including a light-reflecting element that reflects light and a lens layer that refracts incident light received from the exterior toward the light-reflecting element; and a pixel electrode provided on the transflective layer and connected with the switching element.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a layout view of a TFT panel of an LCD according to an embodiment of the invention.

FIG. 2 is a layout view of a common electrode panel of an LCD according to an embodiment of the invention.

FIG. 3 is a layout view of an LCD when the TFT panel of FIG. 1 and the common electrode panel of FIG. 2 are assembled.

FIG. 4 and FIG. 5 are cross-sectional views cut along IV-IV′ and V-V′ of FIG. 3.

FIG. 6 is a view enlarging a portion represented as VI in FIG. 4.

FIG. 7A, FIG. 7B, and FIG. 7C are cross-sectional views of various transflective layers used in the LCD according to an embodiment of the invention.

FIG. 8 is a cross-sectional view of a modified transflective layer used in the LCD according to an embodiment of the invention.

### DESCRIPTION OF THE ILLUSTRATED EMBODIMENTS

Embodiments of the present invention will be described more fully hereinafter with reference to the accompanying drawings, in which preferred embodiments of the invention are shown. The present invention may, however, be embodied in different forms and should not be construed as being limited to the embodiments set forth herein. Rather, these embodiments are provided so that this disclosure will be thorough and complete, and will fully convey the scope of the invention to those skilled in the art.

In the drawings, the thickness of the layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

Hereinafter, LCDs according to embodiments of the invention are described with reference to the accompanying drawings.

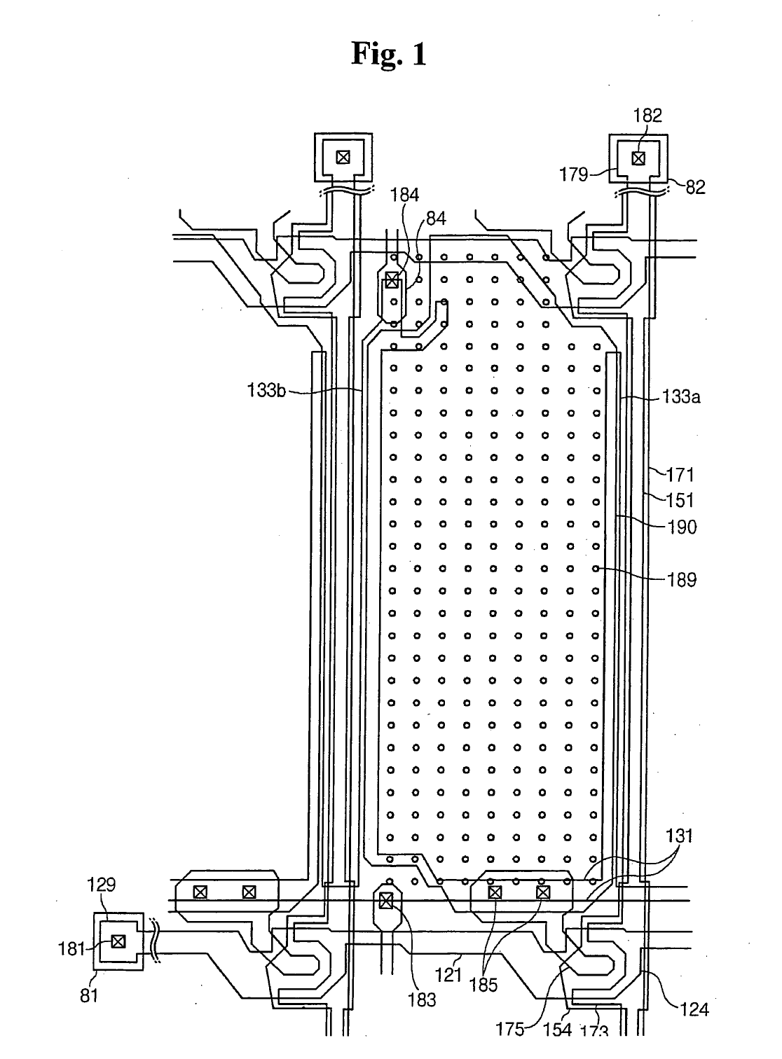

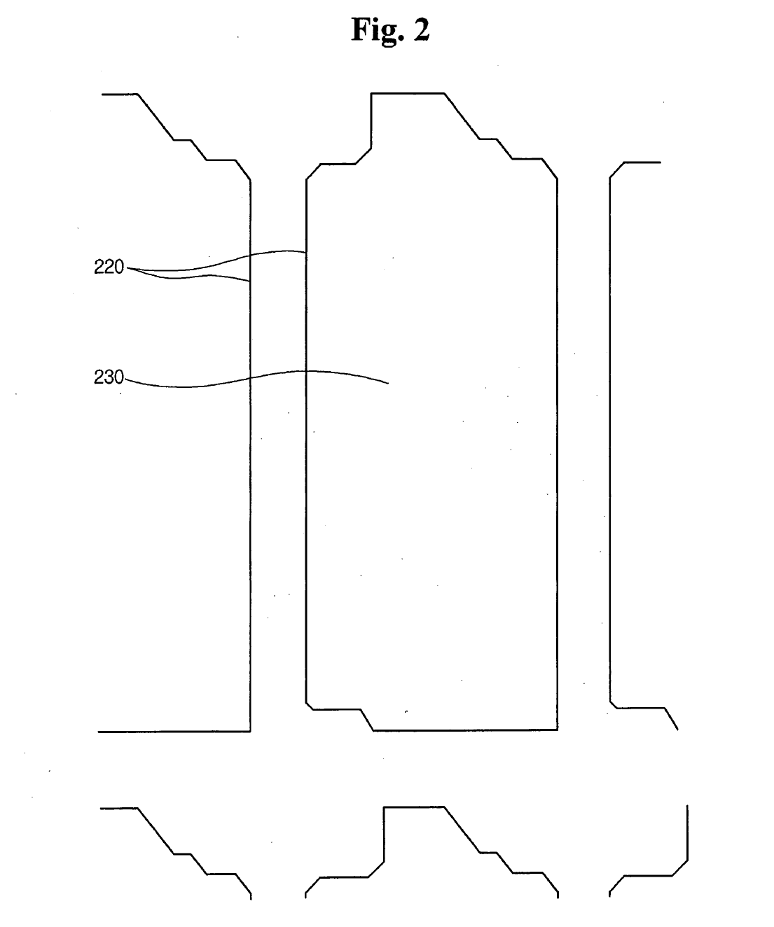

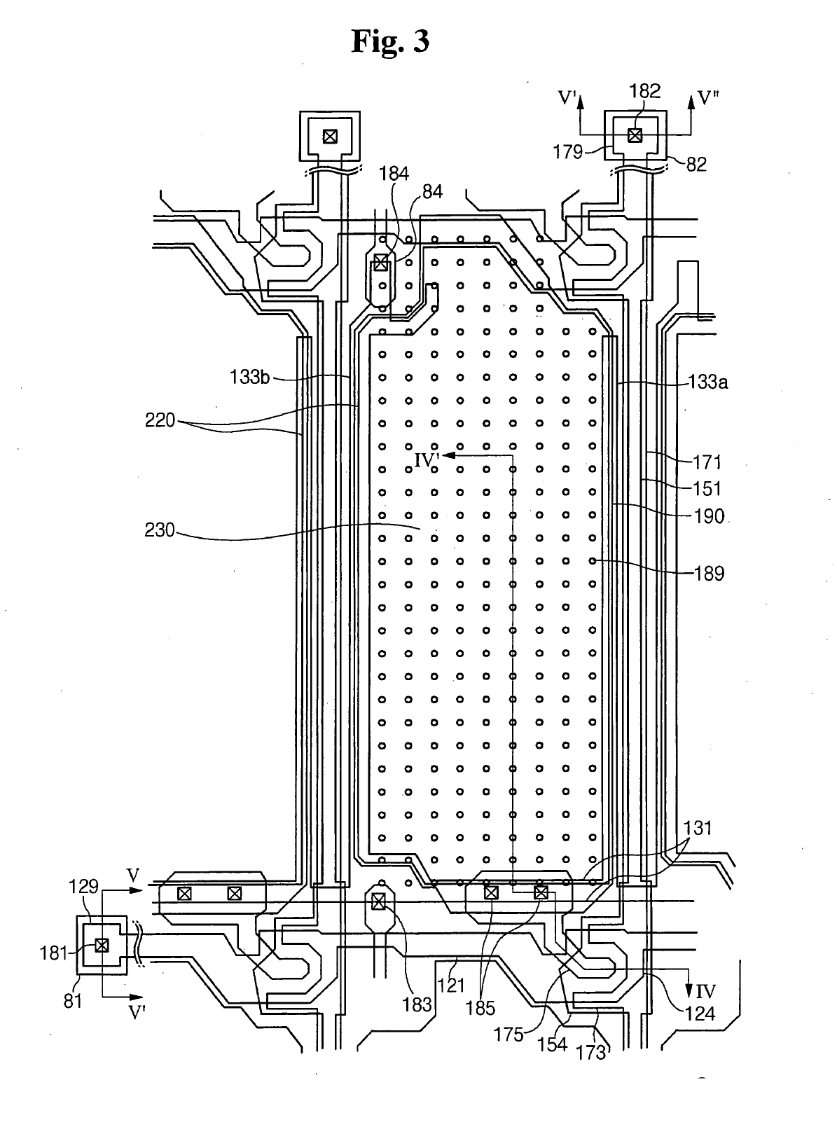

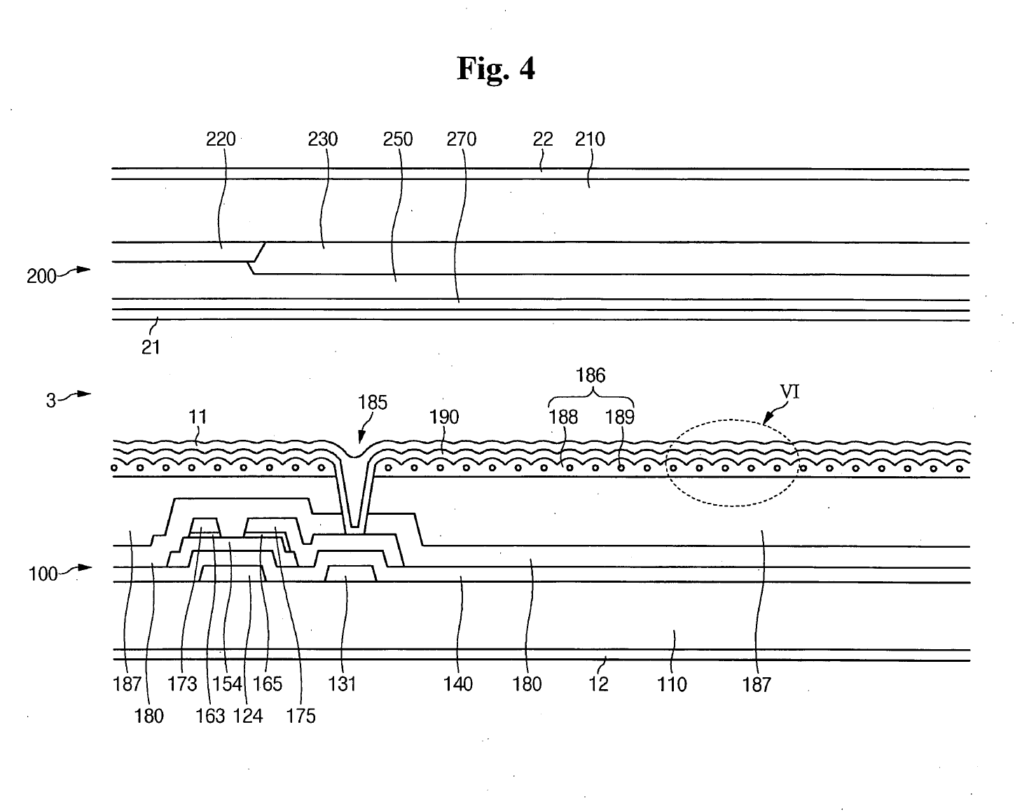

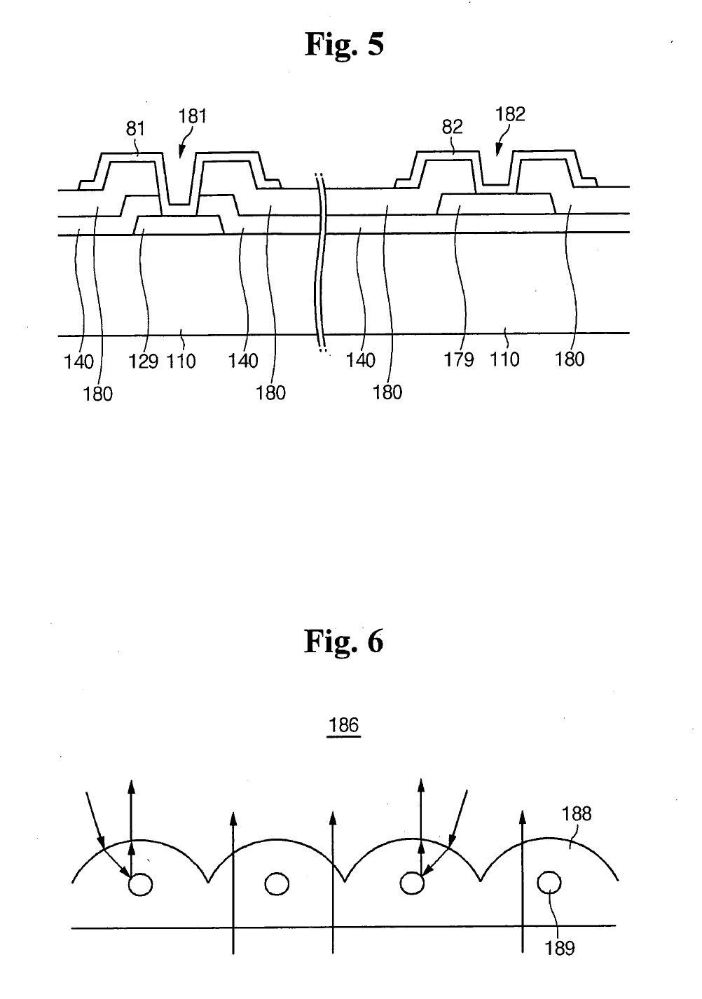

FIG. 1 is a layout view of a TFT panel of an LCD according to an embodiment of the invention. FIG. 2 is a layout view of a common electrode panel of an LCD according to an embodiment of the invention. FIG. 3 is a layout view of an LCD when the TFT panel of FIG. 1 and the common electrode panel of FIG. 2 are assembled. FIG. 4 and FIG. 5 are cross-sectional views along IV-IV′ and V-V′ of FIG. 3.

The LCD includes a TFT panel 100 and a common electrode panel 200 facing each other, and an LC layer 3 interposed therebetween. The LC layer 3 includes LC molecules aligned substantially vertically or substantially horizontally to the surfaces of the two panels 100 and 200.

Hereinafter, the TFT panel 100 is described with reference to FIG. 1, FIG. 3, FIG. 4, and FIG. 5.

A plurality of gate lines 121 and a plurality of storage electrode lines 131 are formed on an insulating substrate 110.

The gate lines 121 are shown to extend in a substantially horizontal direction while being separated from each other, and transmit gate signals. Each gate line 121 includes a plurality of gate electrodes 124 protruding downward and an end portion 129 having a relatively large dimension to connect with an external device. For example, when a gate driving circuit (not shown) for supplying gate signals to the gate lines 121 is integrated into the TFT panel 100, the gate lines 121 may be directly connected with the gate driving circuit, without the enlarged end portions 129.

The storage electrode lines 131 extend in a substantially horizontal direction and include storage electrodes 133a and 133b that extend in a substantially vertical direction. The storage electrode lines 131 receive a predetermined voltage such as a common voltage from a common electrode 270 of the common electrode panel 200.

The gate lines 121 and the storage electrode lines 131 may be made of aluminum (Al) containing metals such as Al and Al alloys, silver (Ag) containing metals such as Ag and Ag alloys, copper (Cu) containing metals such as Cu and Cu alloys, molybdenum (Mo) containing metals such as Mo and Mo alloys, chrome (Cr), titanium (Ti), or tantalum (Ta). The gate lines 121 and the storage electrode lines 131 may have the double-layered structure including two conductive layers (not shown) having different physical properties. For example, one layer may be made of a low resistivity metal such as an Al-containing metal, an Ag-containing metal, or a Cu-containing metal in order to reduce delay of the signals or voltage drop in the gate lines 121 and the storage electrode lines 131, and another layer may be made of a material having prominent physical, chemical, and electrical contact properties with other materials such as indium tin oxide (ITO) and indium zinc oxide (IZO). For example, a Mo-containing metal, Cr, Ta, or Ti may be used for the formation of such layer. The combination of the two layers may include a lower Cr layer and an upper Al (or Al alloy) layer, a lower Al (or Al alloy) layer and an upper Mo (or Mo alloy) layer, etc. In addition to the above-mentioned materials, it is understood that various other metals and conductive materials may be used for the formation of the gate lines 121 and the storage electrode lines 131.

When each gate line 121 includes a lower Cr layer and an upper Al (or Al alloy) layer, the upper layer of the end portion 129 is partially removed, thereby exposing the lower layer thereof.

The lateral sides of the gate lines 121 and the storage electrode lines 131 slope in the range from about 30° to about 80° with respect to the surface of the substrate 110.

A gate insulating layer 140, which may be made of nitride silicon (SiNx), etc., may be formed on the gate lines 121 that are formed on the storage electrode lines 131.

A plurality of linear semiconductors 151, which may be made of hydrogenated amorphous silicon (a-Si) or polysilicon, are formed on the gate insulating layer 140. Each linear semiconductor 151 extends in a substantially vertical direction and includes a plurality of projections 154 that extend along the respective gate electrodes 124.

A plurality of linear ohmic contacts 161 and island-shaped ohmic contacts 165, which may be made of silicide or N+ hydrogenated amorphous silicon that is highly doped with N-type impurities, are formed on the linear semiconductors 151. Each linear ohmic contact 161 includes a plurality of projections 163. A set of the projection 163 and the island-shaped ohmic contact 165 is provided on the projection 154 of the semiconductor 151.

The lateral sides of the semiconductors 151 and the ohmic contacts 161 and 165 slope in the range from about 30° to about 80° against the surface of the substrate 110.

A plurality of data lines 171 and a plurality of drain electrodes 175 are formed on the ohmic contacts 161 and 165 and the gate insulating layer 140.

The data lines 171 extend in a substantially vertical direction and cross the gate lines 121 and the storage electrode lines 131, and transmit data voltages. Each data line 171 includes an end portion 179 having a sufficiently large dimension to connect with another layer or an external device.

Each drain electrode 175 includes an expansion, e.g., a substantially rectangular- or a substantially diamond-shaped expansion, that overlaps with or crosses over the storage electrode line 131. Two substantially horizontal sides of the expansion of the drain electrode 175 are substantially parallel with the storage electrode line 131. The substantially vertical portion of each data line 171 includes a plurality of projections. The partial vertical portion including the two adjacent projections forms a source electrode 173 that partially surrounds an edge of the drain electrode 175. A gate electrode 124, a source electrode 173, a drain electrode 175, and a projection 154 of the semiconductor 151 together form a thin film transistor (TFT). A TFT channel is formed in the projection 154 provided between the source electrode 173 and the drain electrode 175.

The data lines 171 and the drain electrodes 175 may preferably be made of a refractory metal such as a Mo-containing metal, Cr, Ta, Ti, or an alloy thereof. The data lines 171 and the drain electrodes 175 may be formed to have a multi-layered structure that includes a refractory conductive metal layer (not shown) and a low resistivity conductive layer (not shown). For example, the multi-layered structure preferably includes a lower layer made of one among Cr, Mo, and a Mo alloy, and an upper layer made of Al or an Al alloy. Another example of the multi-layered structure includes a lower layer made of Mo or a Mo alloy, an intermediate layer made of Al or an Al alloy, and an upper layer made of Mo or a Mo alloy. In addition to the above-mentioned examples, various other combinations are possible.

Similar to the gate lines 121 and the storage electrode lines 131, the lateral sides of the data lines 171 and the drain electrodes 175 slope in the range from about 30° to about 800 against the surface of the substrate 110.

The ohmic contacts 161 and 165 only exist between the semiconductors 151 and the data lines 171 and between the drain electrodes 175 and the semiconductors 151, in order to reduce contact resistance therebetween.

A passivation layer 180, which may be made of an inorganic insulating material such as SiNx or SiO₂, may be formed on the data lines 171, the drain electrodes 175, and the exposed semiconductors 151 that are not covered with the data lines 171 and the drain electrodes 175.

An organic insulating layer 187, which may be made of a photosensitive organic material having a planarization property, may be formed on the passivation layer 180. On the pad portion including the end portions 125 and 179 of the gate lines 121 and the data lines 171, respectively, the inorganic insulating layer 187 covers the entire pad portion except for the passivation layer 180.

A transflective layer 186 may be formed on the inorganic insulating layer 187. The transflective layer 186 includes a lens layer 188 and light-reflecting elements 189. The lens layer 188, which may be made of a transparent organic material, includes a plurality of convex-shaped protrusions. Each light-reflecting element 189 formed inside the lens layer 188, which may be made of an opaque reflective material such as Al, an Al alloy, Ag, or an Ag alloy, is placed near a focus point of each protrusion of the lens layer 187. The transflective layer 186 is described below.

The passivation layer 180 includes a plurality of contact holes 182 through which the enlarged end portions 179 of the data lines 171 are exposed. The passivation layer 180 is further provided with a plurality of contact holes 181 through which the enlarged end portions 129 of the data lines 121 and the insulating layer 140 are exposed. The passivation layer 180 may further include a plurality of contact holes 185 through the passivation layer 180, the organic insulating layer 187, and the transflective layer 186 in order to expose the drain electrodes 175. A plurality of contact holes 183 and 184 are formed to expose the gate insulating layer 140, the storage electrode lines 131, and the storage electrodes 133b. The contact holes 183 and 184 may expose partial portions of the substrate 110, but the substrate 110 may be not exposed. The contact holes 181 through 185 may have various shapes such as polygon, circle, etc., and lateral sides of the contact holes 181, 182, 183, 184 and 185 may slope in the range from about 30° to about 85° against the surface of the substrate 110 or may have a step-like shape.

A plurality of pixel electrodes 190, which may be made of a transparent conductive material such as ITO or IZO, a plurality of contact assistants 81 and 82, and a plurality of storage bridges 84 may be formed on the passivation layer 180.

The pixel electrodes 190 are physically and electrically connected to or coupled with the drain electrodes 175 through the contact holes 185 to receive the data voltages from the drain electrodes 175. When the data voltage is applied to the pixel electrodes 190, the pixel electrodes 190 generate an electric field in cooperation with the common electrode 270, which affects the orientations of liquid crystal molecules 310 interposed between the two electrodes 100 and 200.

A set of a pixel electrode 190 and a common electrode 270 form a capacitor that is capable of storing the applied voltage when the TFT is turned off. This capacitor is referred to as a “liquid crystal capacitor”. To increase the voltage storage ability, “storage capacitor” may be further provided. The storage capacitor may be connected in parallel with the liquid crystal capacitor. The storage capacitor may be implemented by overlapping or crossing the pixel electrode 190 with the storage electrode line 131. The capacitances of the storage capacitors are increased by providing the storage electrodes 133a and 133b that extend from the storage electrode lines 131 such that the overlap areas and the dimensions of the drain electrodes 175 that are connected with the pixel electrodes 190 are increased, which decreases the distance between the terminals and increases the overlap area.

The pixel electrodes 190 overlap with the gate lines 121 adjacent thereto (referred to as “previous gate lines”) to increase the aperture ratio; however, such overlap portions are not always necessary. Instead, the pixel electrodes 190 may overlap with the gate line 171 adjacent thereto.

The contact assistants 81 and 82 are individually connected with the end portions 129 of the gate lines 121 and the end portions 179 of the data lines 171 through the contact holes 181 and 182, respectively. The contact assistants 81 and 82 protect and provide additional adhesion between the exposed end portions 129 and 179 and exterior devices. The contact assistants 81 and 82 may be omitted as necessary.

When a gate driving circuit is integrated with the TFT panel 100, the contact assistant 81 may connect a metal layer of the gate driving circuit and the gate line 121. Similarly, when a data driving circuit is integrated into the TFT panel 100, the contact assistant 82 may connect a metal layer of the data driving circuit and the data line 121.

The storage bridges 84 span the respective gate lines 121, interconnecting the storage electrode lines 131 and the storage electrodes 133b, which are provided in the adjacent pixel regions. The storage bridges 84 contact the storage electrode lines 131 and the storage electrodes 133b through the contact holes 183 and 184. The storage bridges 84 electrically interconnect or couple the entire storage electrode lines 131 of the lower insulating substrate 110.

An alignment layer 11 may be formed on the pixel electrodes 190, the contact assistants 81 and 82, and the transflective layer 186 to substantially align the LC molecules 310 in the LC layer 3.

The common electrode panel 200 facing the TFT panel 100 is described below with reference to FIG. 2, FIG. 3, and FIG. 4.

A shading device 220, referred to as a “black matrix”, is provided on an insulating substrate 210. The shading device may be made of a transparent material such as glass, to prevent or substantially reduce light leakage between the pixel electrodes 190.

A plurality of color filters 230 may be formed on the substrate 210. A plurality of the color filters 230 are placed within aperture regions defined by the shading device 220, preferably most of the color filters 230 are provided therein. Each color filter 230 may be disposed between the two adjacent data lines 171. Each color filter 230 may exhibit one among a red color, a green color, and a blue color. The color filters 230 may be connected with each other and have a substantially vertical stripe shape.

An overcoat layer 250, which may be made of an organic material may be formed on the color filters 230 and the shading means 220 to protect the color filters 230. The overcoat layer provides a substantially flat surface.

A common electrode 270, which may be made of a transparent conductive material such as ITO or IZO, may be formed on the overcoat layer 250 to receive a common voltage.

An alignment layer 21 may be formed on the common electrode 270 to substantially align the LC molecules in the LC layer 3.

A set of polarizers 12 and 22 may be individually attached with the outer surfaces of the two panels 100 and 200. Their transmission axes substantially perpendicularly intersect one another. For example, the transmission axis of the polarizer 12 attached with the TFT panel 100 may be substantially parallel with the gate line 121. The polarizer 12 is omitted in the reflective LCDs.

Retardation films (not shown) may be individually provided between the TFT panel 100 and the polarizer 12 and/or between the common electrode panel 200 and the polarizer 22 to compensate the retardation values of the LC layer 3. The retardation films may be birefringent films that inversely compensate birefringency of the LC layer 3. For example, uniaxial optical films or biaxial optical films, preferably negative uniaxial optical films, may be used as the retardation films.

The LCD includes a backlight unit (not shown) that supplies light to the polarizers 12 and 22, the retardation films, the two panels 100 and 200, and the LC layer 3. The alignment layers 11 and 21 may be either horizontal alignment layers or vertical alignment layers.

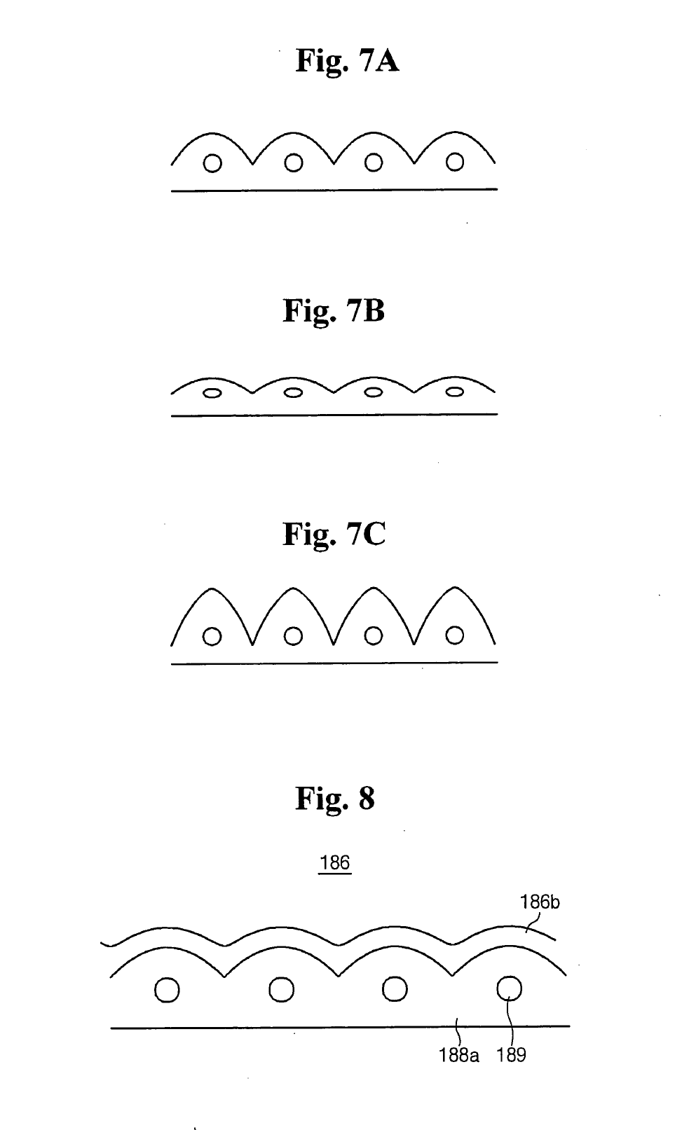

The transflective layer 186 of the LCD according to an embodiment of the invention is described below with reference to FIG. 6, FIG. 7, and FIG. 8.

FIG. 6 is a view enlarging a portion represented as VI in FIG. 4. FIG. 7A, FIG. 7B, and FIG. 7C are cross-sectional views of various transflective layers employed in the LCD according to an embodiment of the invention. FIG. 8 is a cross-sectional view of a modified transflective layer used in the LCD according to an embodiment of the invention.

As shown in FIG. 6, the transflective layer 186 transmits light from the illumination units to a direction away from the illumination units and reflects light from the exterior environment. For example, the transflective layer transmits light received from the illumination units to the upside.

The light originated from the illumination units passes through the substrate 110 and the organic insulating layer 187, and travels to the transflective layer 186. Most of the light from the illumination units exits the LCD after passing through the lens layer 188, which is placed between the light-reflecting elements 189 of the transflective layer 186 and the organic insulating layer 187. The remaining light is reflected by the light-reflecting elements 189. The reflected light travels in various paths. For example, part of the reflected light may proceed to the exterior and the remaining reflected light may proceed in a direction towards the illumination unit; e.g., downward.

The convex-shaped protrusions of the lens layer 188 receive light from the exterior environment. In addition, these protrusions reduce a dazzling like reflection phenomenon, which is caused by the reflected exterior light, by partially dispersing the incident light received from the exterior environment. The convex-shaped protrusions of the lens layer 188 refract the incident light from the exterior toward focus points inside the lens layer 188. As shown in FIG. 7A, FIG. 7B, and FIG. 7C, the protrusions may be designed as a series of hemispheres, spheroids, or polyhedrons. Alternately, the protrusions may be designed in different shapes or having a selective combination of the above-mentioned shapes or different shapes. However, the lens layer 188 may have a flat surface without the protrusions.

The light-reflecting elements 189 have a substantially circular-like shape, e.g., a small circle or oval-shaped horizontal sections, and reflect the exterior light input through the lens layer 188 in a direction that is opposite the illumination unit, e.g., toward the upside.

A diameter of each protrusion of the lens layer 188 ranges from about 0.1 μm to about 100 μm, preferably about 1 μm to about 10 μm, and more preferably about 1 μm to about 3 μm. A diameter of the light-reflecting element 189 is no greater than half the diameter of the protrusion. The diameters of the light-reflecting elements 189 are considered when determining an appropriate balance between the exterior light reflected by the light-reflecting elements 189 and the light input from the illumination units. For example, the diameters of the light-reflecting elements 189 must be sufficiently large to reflect a sufficient amount of exterior light, while they must be controlled to not block too much light from the illumination units. For example, the diameters of the light-reflecting elements 189 may range from about 1/100 to about ½ of the diameter of the lens layer 188, preferably about ⅕ to about ⅓.

The sizes and positions of the protrusions of the lens layer 188 may be uniform or non-uniform. The irregularly or non-uniformly arranged protrusions may prevent an interference phenomenon caused by a regular reflection of the exterior light when the protrusions are provided in a substantially regular pattern. Further, the diameters of the respective light-reflecting elements 189 may also be non-uniform.

The transflective layer 186 may be formed over the entire organic insulating layer 187. Alternatively, the transflective layer 186 may only be formed on a portion of the organic insulating layer 187 corresponding to the pixel electrodes 190.

Due to the transflective layer 186 including the lens layer 188 and the light-reflecting elements 189, all pixels may be used as the aperture areas regardless of the mode, i.e., transmissive or reflective. Accordingly, the transmittance is maximized without any loss of reflectivity or only a minimal loss of reflectivity. In this case, the maximized transmission efficiency is at least about 90%.

Meanwhile, as shown in FIG. 8, a reflective layer 186 according to another embodiment of the invention includes a lens layer 188a, a coating layer 186b, and light-reflecting elements 189. The lens layer 188a and the light-reflecting elements 189 of this embodiment are substantially the same as those described in the above embodiments; therefore descriptions of them are omitted where necessary.

The coating layer 186b is formed on the lens layer 188b, and protrusions of the coating layer 188b form substantially the same shape as the protrusions of the lens layer 188a. Also, the coating layer 186b has substantially the same refraction index as the lens layer 188a, and controls the focuses with respect to the protrusions of the lens layer 188a. The light-reflecting elements 189 are provided at the respective focus points to reflect the incident exterior light in a direction away from the illumination on it; e.g., in an upward direction toward the upside. When the lens layer 188 of FIG. 6 and the lens layer 188a of FIG. 8 have substantially the same diameter and shape and are made of the same material, the focus points of the lens layer 188a, combined with the coating layer 186b, are more closely formed than those of the lens layer 188 in the embodiment shown in FIG. 6. The thickness of the coating layer 188b may be accurately determined for varying the focus points when the light-reflecting elements 189 are provided.

As discussed above, due to the transflective layer 186, which includes the lens layer 188 with the protrusions and the light-reflecting elements 189, an entire aperture area of all pixels may be used, so that the transmittance is maximized without any loss of reflectance.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display (LCD), comprising:
a plurality of signal lines;
a switching element connected with the signal lines;
an insulating layer provided on the switching element;
a transflective layer provided on the insulating layer and comprising a light-reflecting element that reflects light and a lens layer that refracts incident light received from the exterior toward the light-reflecting element; and
a of pixel electrode provided on the transflective layer and connected with the switching element.

2. The LCD of claim 1, wherein the lens layer comprises a protrusion corresponding with the respective light-reflecting element.

3. The LCD of claim 2, wherein the light-reflecting element is formed at a focus of the protrusion of the lens layer.

4. The LCD of claim 3, wherein the light-reflecting element is provided inside the lens layer.

5. The LCD of claim 3, wherein the light-reflecting element comprises at least one of aluminum (Al), Al alloys, silver (Ag), and Ag alloys.

6. The LCD of claim 3, wherein the protrusion of the lens layer comprises a convex surface.

7. The LCD of claim 3, wherein the protrusion of the lens layer comprises a substantially hemisphere-like shape.

8. The LCD of claim 3, wherein the protrusion of the lens layer comprises a substantially ellipsoid-like shape.

9. The LCD of claim 3, wherein the protrusion of the lens layer comprises a substantially polyhedron-like shape.

10. The LCD of claim 3, wherein the light-reflecting elements comprises a substantially ball-like shape or a substantially ellipsoid-like shape.

11. The LCD of claim 3, wherein the light-reflecting element is provided where the pixel electrodes is provided.

12. The LCD of claim 11, wherein the light-reflecting element is irregularly arranged with respect to another light-reflecting element.

13. The LCD of claim 11, wherein the light-reflecting element is regularly arranged with respect to another light-reflecting element.

14. The LCD of claim 3, wherein the protrusion of the lens layer is formed where the pixel electrode is formed.

15. The LCD of claim 14, wherein a diameter of the protrusion of the lens layer ranges from about 0.1 μm to about 100 μm.

16. The LCD of claim 15, wherein a diameter of the light-reflecting element is not greater than the diameter of the protrusion.

17. The LCD of claim 15, wherein the protrusion of the lens layer has a different diameter than another protrusion of the lens layer.

18. The LCD of claim 2, wherein the transflective layer is provided on the lens layer, the transflective layer comprising a coating layer having substantially the same profile as the protrusion of the lens layer.

19. The LCD of claim 18, wherein the light-reflecting element is provided at a focus point of the lens layer combined with the coating layer.
